(19) United States
(12) Patent Application Publication
(10) Pub. No.: US 2006/0276079 A1
(43) Pub. Date: Dec. 7, 2006

(54) ELECTRIC SIGNAL LINE CONNECTOR

(75) Inventor: Chiung-Ling Chen, TAIPEI (TW)

Correspondence Address: CABLENET CO., LTD, PO BOX 108-00403, TAIPEI, TW

(73) Assignees: Chiung-Ling Chen, Wen-Shan District, Taipei City (TW); Kun-Hung Liu, Tan-Shui Town, Taipei Hsien (TW)

(21) Appl. No.: 11/164,600

(22) Filed: Nov. 30, 2005

(30) Foreign Application Priority Data
Jun. 6, 2005 (TW) 094209421

(51) Int. Cl. H01R 9/05

(52) U.S. Cl. 439/578

(57) ABSTRACT

An electric signal connector for fastening to a coaxial cable type signal line is disclosed formed of a locknut, a holding-down tube, a tubular shell and a socket. The tubular shell has a retaining inside wall with an inner diameter made gradually reducing toward inside of the tubular shell for receiving the socket and an inside annular step for stopping against the socket. The socket is stopped against the inside annular step of the tubular shell, having a outside positioning wall peripherally stopped against the retaining inside wall of the tubular shell, and an inside bearing annular step for stopping a tube of conducting material of the coaxial cable type signal line against the barbed portions.

This application claims the priority benefit of Taiwan patent application number 094209421 filed on Jun. 6, 2005.

### BACKGROUND OF THE INVENTION

1. Field of the Invention

The present invention relates to electric connectors and more particularly, to an electric signal line connector, which firmly secures the signal line against twist, enabling the signal line to transmit signal smoothly without noises.

2. Description of the Related Art

An early electric signal line connector is known comprising a connector body, and a thin tube coupled to one end of the connector body. After insertion of the signal line into the thin tube and the connector body, a crimping tool is used to crimp the thin tube, fastening the thin tube to the signal line. When crimping the thin tube, the tin tube may break along the seam thereof, and the signal line may easily be forced out of place or disconnected from the electric signal line connector.

FIGS. 7 and 8 show a prior art electric signal line connector designed to eliminate the aforesaid problem. According to this design, the tubular shell, referenced by A, defines an accommodating chamber A2 and has an inside annular groove A1 extending around the inside wall near the outer end; the socket, referenced by B, has an axial center through hole B2 for the insertion of a coaxial cable type signal line C, a first outside annular flange B1 extending around the periphery near one end, and a second outside annular flange B3 extending around the periphery near the other end. When the electric signal connector is assembled, the first outside annular flange B1 is kept in engagement with the inside annular groove A1 of the tubular shell A. After insertion of the coaxial cable type signal line C into the socket B, the socket B is forced inwards toward the inside of the tubular shell A to move the first outside annular flange B1 away from the inside annular groove A1 and to further move the second outside annular flange B3 into engagement with the inside annular groove A1, thereby holding down the coaxial cable type signal line C.

This design of signal line connector has drawbacks as follows.

1. During the production of the socket, a specially designed mold that is formed of a number of mold blocks is used to mold elastic plastics into the designed shape. Because the mold is formed of a number of mold blocks, the mold cost is relatively high, and the fabrication of the mold is relatively complicated. In consequence, the manufacturing cost of the socket is relatively increased.

2. Because the socket has outside annular flanges, the outside wall of the socket is uneven. When molded from elastic plastics with the mold that is formed of a number of mold blocks, many seam lines are produced, affecting the perfection of the roundness. The seam lines impart a barrier to the insertion of the socket with the coaxial cable type signal line into the tubular shell.

3. Because the periphery of the socket is not a smooth surface and has a raised and recessed profile, the detective rate of the manufacturing of the socket is relatively high.

4. Because the mold for molding the socket consists of a number of mold blocks, the calibration and alignment of the installation of the mold blocks are relatively complicated, affecting the precision of the size.

### SUMMARY OF THE INVENTION

The present invention has been accomplished under the circumstances in view. It is one object of the present invention to provide an electric signal line connector, which firmly secures the signal line in place when installed. It is another object of the present invention to provide an electric signal line connector, which is easy and inexpensive to manufacture.

To achieve these and other objects of the present invention, the electric signal connector electric signal line connector comprising a locknut, a holding-down tube coupled to the locknut, the holding-down tube having at least one barbed portion at the periphery of one end thereof, a tubular shell coupled to and surrounding the holding-down tube, and a socket coupled to one end of the tubular shell remote from the locknut hold down a tube of conducting material of a coaxial cable type signal line on the at least one barbed portion of the holding-down tube for enabling a center conductor of the coaxial cable type signal line to be suspending in the holding-down tube and partially extending out of the locknut, wherein the tubular shell has a retaining inside wall adapted to receive the socket and an inside annular step at an inner side of the retaining inside wall for stopping against the socket, the retaining inside wall having an inner diameter made gradually reducing toward inside of the tubular shell; the socket is stopped against the inside annular step of the tubular shell, having a outside positioning wall peripherally stopped against the retaining inside wall of the tubular shell, and an inside bearing annular step adapted to stop the tube of conducting material of the coaxial cable type signal line against the at least one barbed portion.

### BRIEF DESCRIPTION OF THE DRAWINGS

FIG. 1 is an elevational view of an electric signal line connector according to the present invention.

FIG. 2 is an exploded view of the electric signal line connector according to the present invention.

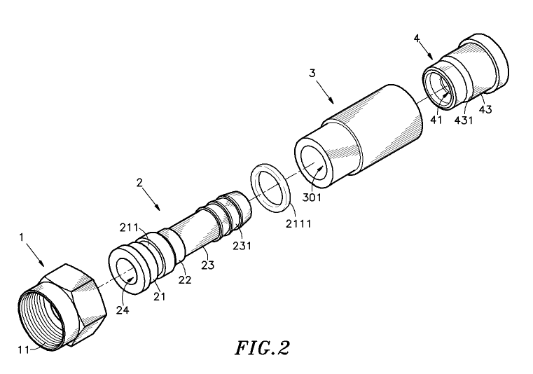

FIG. 3 is a schematic sectional assembly view of the electric signal line connector according to the present invention.

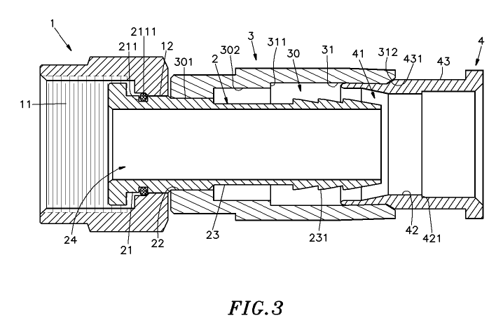

FIG. 4 is a schematic sectional view showing the relationship between the electric signal line connector and the signal line according to the present invention before connection.

FIG. 5 is a sectional side view showing the signal line inserted into the electric signal line before locking according to the present invention.

FIG. 6 corresponds to FIG. 5, showing the electric signal line connector and the signal line locked according to the present invention.

FIG. 7 is a side view in section of an electric signal line connector according to the prior art.

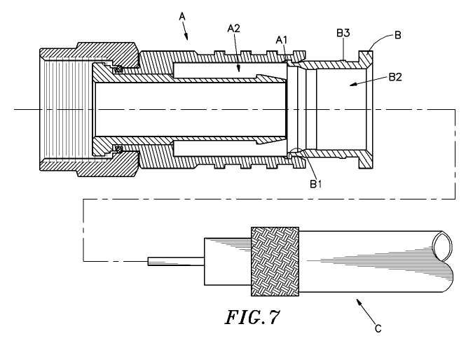

FIG. 8 is an elevational view in an enlarged scale of the socket shown in FIG. 7.

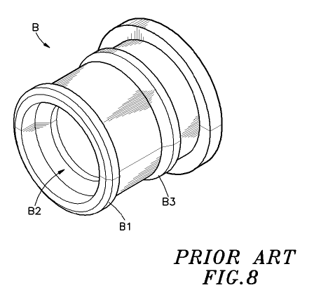

### DETAILED DESCRIPTION OF THE PREFERRED EMBODIMENT

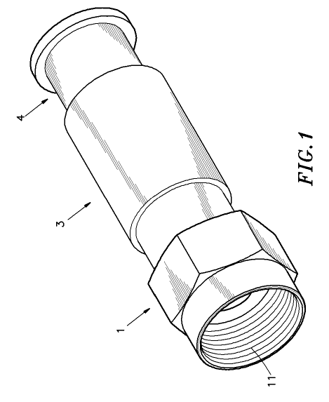

Referring to FIGS. 1˜3, an electric signal line connector in accordance with the present invention is shown comprising a locknut 1, a holding-down tube 2, a tubular shell 3, and a socket 4.

The locknut 1 has an inner thread 11 at one end, and an stop flange 12 at the other end.

The holding-down tube 2 comprises a tubular bearing portion 21, a locating groove 211 extending around the periphery of the tubular bearing portion 21, a tubular extension 23 axially extending from one end of the tubular bearing portion 21, a tubular coupling portion 22 axially connected between the tubular bearing portion 21 and the tubular extension 23, an axial center through hole 24 surrounded by the tubular bearing portion 21 and the tubular coupling portion 22 and the tubular extension 23, and a plurality of barbed portions 231 extending around the distal end of the tubular extension 23 remote from the tubular bearing portion 21 and the tubular coupling portion 22. Further, a gasket ring 2111 is mounted in the locating groove 211 around the periphery of the tubular bearing portion 21.

The tubular shell 3 has an accommodating chamber 30 extending through the two distal ends thereof, a coupling hole 301 formed in one, a beveled guide edge 312 formed in the other end, a retaining inside wall 31 axially connected between the coupling hole 301 and the beveled guide edge 312, a locating hole 302 axially connected between the coupling hole 301 and the retaining inside wall 31, and an inside annular step 311 disposed at the connection area between the retaining inside wall 31 and the locating hole 302. Further, the retaining inside wall 31 has an inner diameter larger than an inner diameter of the locating hole 302.

The socket 4 has an axial center through hole 41 extending through the two distal ends thereof, an inside bearing wall 42 formed in the axial center through hole 41, an inside bearing annular step 421 abutted against one end of the inside bearing wall 42, an outside positioning wall 43 extending around the periphery, and a beveled guiding portion 431 extending around the periphery at one end of the outside positioning wall 43.

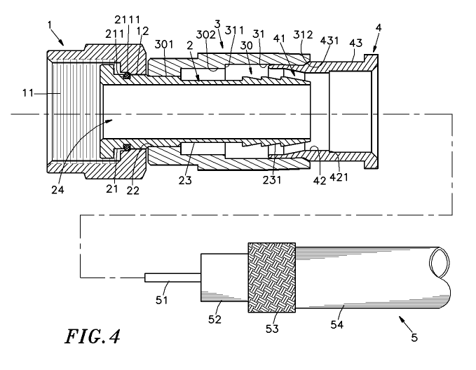

The assembly process of the electric signal line connector is outlined hereinafter with reference to FIG. 4. At first, the holding-down tube 2 is inserted through the locknut 1 to have the tubular bearing portion 21 and the gasket ring 2111 be stopped in the inside stop flange 1 2 of the locknut 1 and the tubular coupling portion 22 and the tubular extension 23 be suspending outside the locknut 1, and then the tubular shell 3 is sleeved onto the holding-down tube 2 to force the coupling hole 301 of the tubular shell 3 into engagement with the tubular coupling portion 22 of the holding-down tube 2 and to have the tubular extension 23 and the barbed portion 231 of the holding-down tube 2 be suspending in the accommodation chamber 30 of the tubular shell 3, and then socket 4 is inserted into one end of the tubular shell 3 remote from the locknut 1 to abut the beveled guiding portion 431 of the socket 4 against the beveled guide edge 312 of the tubular shell 3.

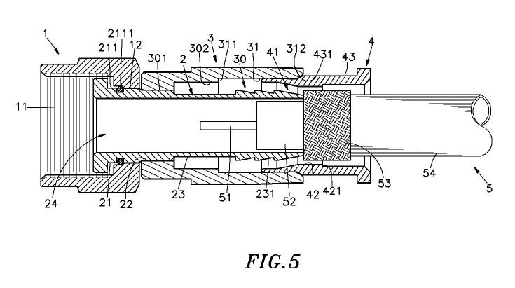

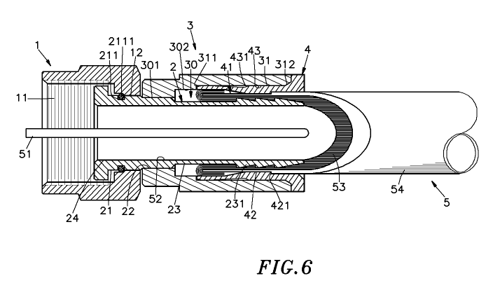

Referring to FIGS. 5 and 6, a signal line 5 is a coaxial cable having a central conductor 51, a tubular insulator 52 that holds the central conductor 51 in place, a tube of conducting material 53 surrounding the tubular insulator 52, and an outer insulative covering 54 surrounding the tube of conducting material 53. During installation, the signal line 5 is inserted into the axial center through hole 41 of the socket 4 to force the central conductor 51 and the tubular insulator 52 into the axial center through hole 24 of the holding-down tube 2 and to stop the tube of conducting material 53 against the barbed portions 231 and the free end of the tubular extension 23 of the holding-down tube 2, and then the socket 4 is forced inwards to move the beveled guiding portion 431 of the socket 4 over the beveled guide edge 312 of the tubular shell 3 and to force the outside positioning wall 43 of the socket 4 into engagement with the retaining inside wall 31 inside the tubular shell 3. At this time, the outside positioning wall 43 is radially forced outwards by the signal line 5 against the retaining inside wall 31, the inside bearing portion 42 of the socket 4 is forced by the tubular shell 3 to compress the tube of conducting material 53 and the outer insulative covering 54 of the signal line 5 against the barbed portions 231 of the holding-down tube 2 within the tubular shell 3, and the center conductor 51 of the signal line 5 is held extending to the outside of the locknut 1. The installation procedure is down when the end edge of the socket 4 is stopped against the inside annular step 311 of the tubular shell 3.

The aforesaid socket 4 is made out of an elastic plastic material that is plastically deformable. The outer diameter of the outside positioning wall 43 of the socket 4 is slightly greater than the inner diameter of the retaining inside wall 31 of the tubular shell 3 so the outside positioning wall 43 is firmly stopped against the retaining inside wall 31 when forced the socket 4 into the inside of the tubular shell 3, preventing disconnection of the socket 4 from the tubular shell 3 after installation of the signal line connector.

As indicated above, the electric signal line connector of the present invention as the following features.

1. After installation of the electric signal connector, the inside bearing annular step of the socket stops the tube of conducting material against the barbed portions of the holding-down tube, preventing disconnection of the signal line from the socket upon an impact.

2. During the production of the socket, a simple mold that is formed of a limited number of mold blocks is used to mold elastic plastics into the designed shape. This socket manufacturing process is simple and inexpensive, saving much connector manufacturing time and improving much the working efficiency.

3. Because the socket has a smooth outer surface without concave, it can directly be molded from elastic plastics with one simple mold. When the socket is made, it does not have any seam line, i.e., the periphery of the socket has a perfect roundness for positive positioning in the tubular shell after insertion of the socket into the tubular shell.

4. Because the periphery of the socket is a smooth surface without raised or recessed portions, the yield rate of the manufacturing of the socket is high.

5. Because the mold for molding the socket consists of a limited number of mold blocks, the calibration and alignment of the installation of the mold blocks are quite simple, assuring a high precision of the size.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electric signal line connector comprising a locknut, a holding-down tube coupled to said locknut, said holding-down tube having at least one barbed portion at the periphery of one end thereof, a tubular shell coupled to and surrounding said holding-down tube, and a socket coupled to one end of said tubular shell remote from said locknut hold down a tube of conducting material of a coaxial cable type signal line on said at least one barbed portion of said holding-down tube for enabling a center conductor of said coaxial cable type signal line to be suspending in said holding-down tube and partially extending out of said locknut, wherein said tubular shell has a retaining inside wall adapted to receive said socket and an inside annular step at an inner side of said retaining inside wall for stopping against said socket, said retaining inside wall having an inner diameter made gradually reducing toward inside of said tubular shell; said socket is stopped against said inside annular step of said tubular shell, having a outside positioning wall peripherally stopped against said retaining inside wall of said tubular shell, and an inside bearing annular step adapted to stop said tube of conducting material of said coaxial cable type signal line against said at least one barbed portion.

2. The signal line connector as claimed in claim 1, wherein said socket is molded from plastics.

3. The signal line connector as claimed in claim 1, wherein said socket has a beveled guiding portion at one end of said outside positioning wall for guiding said outside positioning wall into engagement with said retaining inside wall of said tubular shell.
